(19) United States
(12) Patent Application Publication
(10) Pub. No.: US 2025/0282340 A1
(43) Pub. Date: Sep. 11, 2025

(54) MOTOR VEHICLE AND METHOD FOR BRAKING A MOTOR VEHICLE WITH A VEHICLE MOTION CONTROL SYSTEM

(71) Applicants: thyssenkrupp Presta AG, Eschen (LI); thyssenkrupp AG, Essen (DE)

(72) Inventors: Leonard LAPIS, Sennwald (CH); Barna SZIMANDL, Gams (CH); Zoltan Szabolcs ERDELYI, Budapest (HU)

(73) Assignees: thyssenkrupp Presta AG, Eschen (LI); thyssenkrupp AG, Essen (DE)

(21) Appl. No.: 19/073,489

(22) Filed: Mar. 7, 2025

(30) Foreign Application Priority Data
Mar. 11, 2024 (BE) BE 2024/5140

(51) Int. Cl. B60W 10/184; B60W 10/20; B60W 30/18

(52) U.S. Cl. CPC B60W 10/184; B60W 10/20; B60W 30/18145; B60W 2520/26; B60W 2520/28

(57) ABSTRACT

A method for braking a motor vehicle including a vehicle motion control system and a braking system with electromechanical brake actuators, wherein each wheel of the motor vehicle is assigned one of the electromechanical brake actuators, comprises the vehicle motion control system receiving a driving direction input comprising a deceleration input, an actual vehicle speed, and an actual wheel rotational speed for each wheel of the motor vehicle, the vehicle motion control system determining a reference driving line for the motor vehicle on the basis of the received driving direction input and the received actual vehicle speed, the vehicle motion control system determining a desired wheel rotational speed which is required to comply with the reference driving line and to implement the deceleration input, and the vehicle motion control system activating the brake actuators, taking into consideration the respectively received actual wheel rotational speed, in such a way that the actual wheel rotational speed is adjusted to the desired wheel rotational speed.

### CROSS REFERENCE TO RELATED APPLICATION

This application is a U.S. Non-Provisional that claims priority to Belgian Patent Application No. BE 2024/5140, filed Mar. 11, 2024, the entire content of which is incorporated herein by reference.

### FIELD

The present disclosure relates to a method for braking a motor vehicle, comprising a braking system with electromechanical brake actuators.

### BACKGROUND

WO 2021/197554 A1 discloses a braking system with a central control unit and wheel-individual control units, wherein each wheel of a motor vehicle is assigned an electromechanical wheel brake and at least one wheel rotational speed sensor, and wherein a deceleration torque applied by the wheel brake is controlled by control of the application force of the wheel brake. The wheel rotational speed detected by means of the wheel rotational speed sensors can be used to determine wheel slip and to activate the wheel brake in such a way that the slip remains within defined limits.

Measuring a braking force or an application force is not without problems, because of dependency of the brakes on temperature and wear. In addition, the corresponding sensors for detecting the braking force are costly.

In addition, EP 3 938 260 B1 discloses a method for control of a steering system and of a differential braking system of a motor vehicle, wherein the motor vehicle comprises a vehicle motion control system (also VMC system for short).

Thus a need exists to provide a motor vehicle and a method for braking a motor vehicle, which advantageously allow an alternative activation, in particular a more cost-effective activation, of the brakes, and advantageously make sensors for detecting the braking force unnecessary.

### BRIEF DESCRIPTION OF THE FIGURES

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 shows a highly simplified side view of an exemplary embodiment of a motor vehicle as described herein.

FIG. 2 shows a highly simplified top view of the motor vehicle from FIG. 1, which is being braked as described herein.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

Embodiments relate to a method for braking a motor vehicle, comprising a braking system with electromechanical brake actuators, wherein each wheel of the motor vehicle is assigned one of the electromechanical brake actuators. Furthermore, the invention relates to a motor vehicle comprising a braking system with electromechanical brake actuators, wherein each wheel of the motor vehicle is assigned in each case one of the electromechanical brake actuators and a wheel rotational speed sensor for detecting an actual wheel rotational speed of the wheel.

The proposed solution provides a method for braking a motor vehicle, wherein the motor vehicle comprises a vehicle motion control system and a braking system with electromechanical brake actuators. Each wheel of the motor vehicle is assigned one of the electromechanical brake actuators. According to the method, the vehicle motion control system receives a driving direction input comprising a deceleration input, in particular a driving direction input predetermined by a vehicle user or an autonomous driving (AD) system, an actual vehicle speed, and an actual wheel rotational speed for each wheel of the motor vehicle. On the basis of the received driving direction input and the received actual vehicle speed, the vehicle motion control system determines a reference driving line for the motor vehicle, and a desired wheel rotational speed which is required to comply with the reference driving line and to implement the deceleration input. Furthermore, the vehicle motion control system activates the brake actuators, taking into consideration the respectively received actual wheel rotational speed, in such a way that the actual wheel rotational speed is controlled to the desired wheel rotational speed. The brake actuators are therefore advantageously actuated by the activation system in such a way that the actual wheel rotational speed is reduced such that the desired wheel rotational speed is reached. Advantageously, no information regarding the braking force or the application force of the brake actuators is required in this case. In this respect, the method can advantageously be carried out without corresponding sensors for detecting a braking force or an application force. However, the method may be provided in particular also as a backup system of a method primarily controlled by braking force for braking a motor vehicle in order to provide safe braking even in the event of failure of one or more or all of the brake force sensors.

A particularly advantageous refinement of the method makes provision that the motor vehicle comprises a steering system, in which the steering of the steerable wheels of the steering system is designed according to the Ackermann principle, wherein the vehicle motion control system uses the Ackermann geometry on which the Ackermann principle is based for determining the desired wheel rotational speed. The Ackermann geometry refers to the geometric arrangement of the linkages in the steering system, in which the axles of all of the wheels are arranged as circle radii with a common centre point. This arrangement is advantageously used to avoid lateral slipping of the tyres when cornering.

Advantageously, a motor vehicle braked according to a method designed according to the invention can be braked safely, stably and efficiently. Advantageously, the lateral wheel slip is reduced, in particular minimized, in accordance with the Ackermann geometry in particular by the method or the control cycle on which the method is based being operated continuously. Advantageously, the vehicle can be braked and stabilized at the same time, with in particular the physical limits being taken into consideration.

Further advantageously, for determining the desired wheel rotational speed, the vehicle motion control system takes into consideration a reference wheel slip, which results from the driving direction input, and the received actual vehicle speed, in particular also with the Ackermann geometry being taken into consideration. Advantageously, as a result, the vehicle is braked more safely and the vehicle remains better controllable.

In particular, provision is made that the vehicle motion control system determines a desired wheel rotational speed for each wheel of the motor vehicle. The vehicle motion control system advantageously activates the brake actuator, which is assigned to a wheel, in accordance with the desired wheel rotational speed determined for the wheel, in particular in such a way that each wheel assumes the desired wheel rotational speed determined for this wheel. It is advantageous that the vehicle is braked even more safely and the vehicle remains even better controllable as a result.

According to a further advantageous refinement of the method, the brake actuators are activated without the use of a braking force sensor. In particular, no exerted application force is determined and/or taken into consideration for the activation of the brake actuators. This advantageously results in a cost advantage. In addition, the problems of braking force sensors in respect of their dependency on temperature and wear of the brakes are circumvented.

The vehicle motion control system advantageously comprises a plurality of actuators, with which in particular longitudinal, transverse and/or vertical dynamics of the motor vehicle can be influenced. A further advantageous refinement makes provision that the driving direction input comprises a steering input detected by a steer-by-wire steering system of the motor vehicle. In particular, the steering input can be a detected steering wheel angle. Furthermore, the steering input may comprise in particular an applied steering torque. Advantageously, the steer-by-wire steering system is designed as a component of the vehicle motion control system, as a result of which, advantageously, the steering input can be transmitted via an already existing communication connection.

Advantageously, the driving direction input comprises a deceleration input detected by a brake-by-wire braking system of the motor vehicle. The brake-by-wire braking system is advantageously designed as a component of the vehicle motion control system, as a result of which, advantageously, the deceleration input can be transmitted via an already existing communication connection. Advantageously, the reaction time can also thus be increased and braking of the motor vehicle can thus be further improved.

Further advantageously, the driving direction input comprises an acceleration input detected by a drive-by-wire drive system of the motor vehicle. The acceleration input may in particular also be a deceleration input, in particular when a driver takes the foot off an acceleration pedal of the motor vehicle. The drive-by-wire drive system is advantageously designed as a component of the vehicle motion control system, as a result of which, advantageously, the acceleration input can be transmitted via an already existing communication connection. Advantageously, the reaction time can thus be further increased and braking of the motor vehicle can also be further improved.

In some embodiments, a motor vehicle comprises a vehicle motion control system, a steer-by-wire steering system, and a braking system with electromechanical brake actuators, wherein each wheel of the motor vehicle is assigned in each case one of the electromechanical brake actuators and a wheel rotational speed sensor for detecting an actual wheel rotational speed of the wheel. The vehicle motion control system of the motor vehicle is designed to receive a driving direction input comprising a deceleration input, in particular a driving direction input predetermined by a vehicle user or by an AD driving system, an actual vehicle speed, and an actual wheel rotational speed for each wheel of the motor vehicle. Furthermore, the vehicle motion control system is designed, on the basis of the driving direction input and the vehicle speed, to determine a reference driving line for the motor vehicle and a desired wheel rotational speed which is required to comply with the reference driving line and to implement the deceleration input, for which purpose the vehicle motion control system in particular comprises a correspondingly designed control unit with a computing unit. Furthermore, the vehicle motion control system, in particular the control unit of the vehicle motion control system, is designed to activate the brake actuators, taking into consideration the respectively received actual wheel rotational speed, and, in the process, to control the actual wheel rotational speed to the desired wheel rotational speed. By guiding of the actual wheel rotational speed towards the desired wheel rotational speed, the motor vehicle is advantageously safely braked in accordance with the deceleration input while maintaining the reference driving line. In particular, the advantages described in conjunction with the description of the proposed method are correspondingly applicable to the proposed motor vehicle. The control unit of the vehicle motion control system may be designed in particular as a central control unit. Alternatively, a decentralized control unit may also, however, be provided, with the vehicle motion control system then comprising a plurality of control units which are in particular assigned to one actuator unit each and control said actuator unit. This makes it advantageously possible to develop control systems more freely at vehicle level and to direct the focus on the vehicle dynamics. In addition, the effect can advantageously be achieved that the brake actuators provide a better performance when they are internally controlled by an assigned actuator control unit and not by a central control unit. Decoupling thus promotes greater adaptability, performance and efficiency of the overall system, and enables a more modular and more specialized approach to vehicle control.

In particular, it is provided that the vehicle motion control system comprises a steer-by-wire steering system and/or a brake-by-wire braking system and/or a drive-by-wire drive system as components for influencing longitudinal, transverse and/or vertical dynamics of the motor vehicle. More particularly, the vehicle motion control system may comprise an active damping system. Advantageously, a multiplicity of driving state parameters describing the driving state of the motor vehicle are available to the vehicle motion control system, in particular to a central control unit of the vehicle motion control system. Thus, advantageously, the reference driving line for the motor vehicle can be determined better and the maintaining thereof by the motor vehicle can be controlled.

Particularly advantageously, provision is made that the motor vehicle is designed in such a way that the steerable wheels of the motor vehicle are designed in accordance with an axle-pivot steering system according to the Ackermann principle. The vehicle motion control system, in particular the control unit of the vehicle motion control system, is advantageously further designed to use the Ackermann geometry on which the Ackermann principle is based for determining the desired wheel rotational speed. Adherence to the Ackermann geometry advantageously improves the lateral control of the vehicle and forces the latter in particular into ideal behaviour, in which the lateral slip of the tyres is minimal. Advantageously, the vehicle motion control system is further designed to activate each brake actuator individually, as a result of which the vehicle can be braked even more safely.

Further advantageously, the motor vehicle does not comprise any sensors for detecting a braking force and/or an application force. This can save costs. However, as a configuration variant, it may also be provided in particular that the motor vehicle can be braked by means of the correspondingly configured vehicle motion control system via the wheel rotational speed control and additionally also can be braked by a braking force control, with redundancy in the event of a functional impairment of one of the configurations being realized by the two configurations.

In particular, provision is made that the motor vehicle is designed to be braked in accordance with a method designed according to the invention. In particular, the vehicle motion control system of the motor vehicle, more particularly a control unit of the vehicle motion control system of the motor vehicle, is designed to carry out the method steps to be carried out according to the method by a vehicle motion control system.

In the various figures, identical parts are generally provided with the same reference signs and are therefore also, in some cases, each explained only in conjunction with one of the figures.

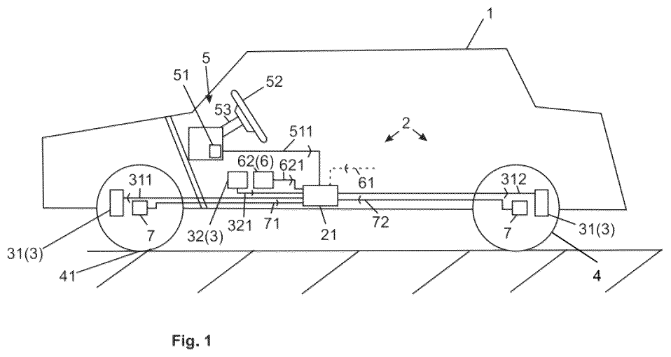

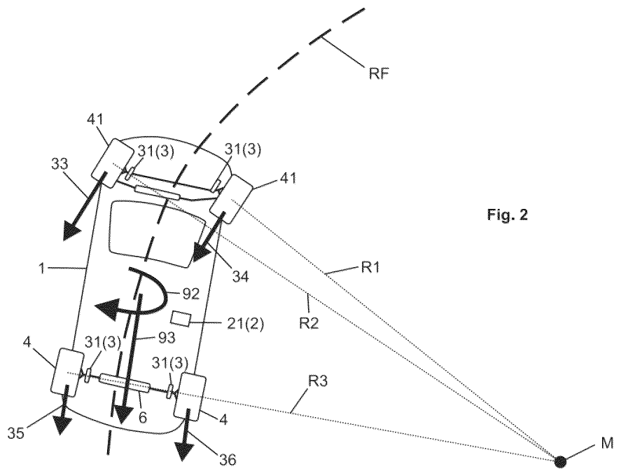

FIG. 1 schematically illustrates an exemplary embodiment of a motor vehicle 1 designed according to the invention, which motor vehicle in this case is a two-track passenger car. FIG. 2 shows the motor vehicle 1 in a schematic top view, wherein the motor vehicle 1 is braked according to an exemplary embodiment of a method designed according to the invention. As schematically indicated in FIG. 2, the steerable wheels 41 of the motor vehicle 1 are designed to be steerable via an axle-pivot steering system, wherein the axle-pivot steering system is designed according to the Ackermann principle, and therefore the Ackermann geometry, which refers to the geometric arrangement of the linkages in the steering system, can be used. According to the Ackermann geometry, the axles of all of the wheels 4, 41 of the motor vehicle 1 are arranged as circle radii R1, R2, R3 with a common centre point M, as sketched in FIG. 2. The Ackermann geometry prevents the tyres of the wheels 4, 41 from slipping to the side when driving around a bend, which greatly reduces the lateral slip of the tyres.

The motor vehicle 1 has a vehicle motion control system 2 with which the driving dynamics of the motor vehicle 1, in particular the driving dynamics in the longitudinal and transverse directions of the motor vehicle 1, can be influenced. The vehicle motion control system 2 comprises a steer-by-wire steering system 5, a brake-by-wire braking system 3 and a drive-by-wire drive system 6. The steer-by-wire steering system 5, the brake-by-wire braking system 3 and the drive-by-wire drive system 6 are connected to a central electronic control unit 21 (ECU; ECU: Electronic Control Unit) of the vehicle motion control system 2 for the purpose of transmitting signals.

The steer-by-wire steering system 5 comprises a steering handle 52 which is arranged on a steering shaft 53 for rotation therewith and via which a vehicle user can specify a steering command. A feedback actuator 51 of the steer-by-wire steering system 5, which feedback actuator is designed to apply a steering resistance torque to the steering shaft 53, comprises the sensor system, in particular a steering angle sensor, which is designed to detect the steering command specified by a vehicle user as a steering input 511 and to transmit same to the control unit 21 of the vehicle motion control system 2.

The brake-by-wire braking system 3 of the motor vehicle 1 comprises four electromechanical brake actuators 31, in which in particular brake shoes can be brought into engagement with a brake disc via a servo motor. The brake actuators 31 are each assigned to a wheel 4, 41 of the motor vehicle 1, wherein each of the brake actuators 31 can be individually activated by the control unit 21 of the vehicle motion control system 2. The wheels 4, 41 of the motor vehicle 1 are also each assigned a wheel rotational speed sensor 7, which is designed for detecting an actual wheel rotational speed 71, 72 of the respective wheel 4, 41. The actual wheel rotational speed 71, 72 of each wheel 4, 41 is continuously transmitted to the control unit 21 of the vehicle motion control system 2 during operation of the motor vehicle 1. In this exemplary embodiment, the motor vehicle 1, in particular the braking system 3 of the motor vehicle 1, has no sensors for detecting a braking force or application force exerted by one of the brake actuators 31.

In the exemplary embodiment shown, a vehicle user can specify a braking command via a brake pedal 32 of the braking system 3, wherein the actuation of the brake pedal is detected by sensor, in particular with regard to the applied actuation force and the actuation distance, and the signals that are detected by sensor are transmitted as a deceleration input 321 to the control unit 21 of the vehicle motion control system 2.

The drive-by-wire drive system 6 may in particular comprise at least one electric motor for driving the drive wheels of the motor vehicle 1. A vehicle user can specify a command regarding the driving speed of the motor vehicle 1 via an acceleration pedal 62, for historical reasons referred to as a gas pedal. The actuation of the accelerator pedal is detected by sensor, in particular with regard to the actuation distance or the change in the actuation distance. The signals detected by sensor in this case are then transmitted as an acceleration input 621 to the control unit 21 of the vehicle motion control system 2, which then correspondingly activates the at least one drive unit of the drive-by-wire drive system 6 to implement the acceleration input 621. The respectively current actual vehicle speed 61 of the motor vehicle 1 is also continuously transmitted to the control unit 21 of the vehicle motion control system 2.

In particular, according to a configuration variant not shown here, provision may also be made that the motor vehicle 1 is not controlled by a vehicle user, but by an AD driving system, wherein in this case the AD driving system transmits the information regarding a steering input, a deceleration input and an acceleration input to the control unit 21 of the vehicle motion control system 2. Furthermore, in a configuration variant not shown here either, the control unit 21 of the vehicle motion control system 2 can be decentralized. In this case, the vehicle motion control system 2 can in particular comprise control units which are respectively assigned to the actuator units 31 and via which the vehicle motion control system 2 can in particular activate the brake actuators, in particular in accordance with a corresponding input by the vehicle motion control system 2.

In any case, in this exemplary embodiment and in the configuration variant which is not illustrated and according to which the vehicle is controlled by an AD driving system, the control unit 21 of the vehicle motion control system 2 is designed to receive a driving direction input, which comprises a steering input 511, a deceleration input 321 and an acceleration input 621, and a current actual vehicle speed 61 of the motor vehicle 1 and an actual wheel rotational speed 71, 72 for each wheel 4, 41 of the motor vehicle 1. On the basis of the received driving direction input and the actual vehicle speed 61, the control unit 21 of the vehicle motion control system 2 continuously determines a reference driving line RF for the motor vehicle 1, that the motor vehicle 1 is intended to follow in accordance with the received driving direction input. Furthermore, for each of the wheels 4, 41 of the motor vehicle 1, the control unit 21 of the vehicle motion control system 2 determines a desired wheel rotational speed, which the respective wheel 4, 41 has to adopt so that the motor vehicle 1 continues to follow the reference driving line RF and therefore the received deceleration input 321 is converted into a corresponding deceleration of the motor vehicle.

For the determination of the desired wheel rotational speed by the vehicle motion control system 2, use is made of the Ackermann geometry, on which the Ackermann principle is based and which applies because of the configuration of the steered wheels. In addition, for the determination of the desired wheel rotational speed, a reference wheel slip resulting from the driving direction input with the Ackermann geometry as the basis and the current actual vehicle speed 61 are taken into consideration. The reference driving line RF determined by the control unit 21 of the vehicle motion control system 2 is advantageously converted by the control unit 21 into a resulting Ackermann geometry (determination of the centre point M and the circle radii R1, R2, R3; cf. FIG. 2), wherein then, advantageously, with this resulting Ackermann geometry being taken into consideration, the desired wheel speed for each of the wheels 4, 41 is determined.

The control unit 21 of the vehicle motion control system 2 then activates the respective brake actuators 31 with activation signals 311, 312 generated on the basis of the determined target wheel rotational speeds and taking into consideration the real actual wheel rotational speeds 71, 72. The braking intervention of the brake actuators 31 that is caused by the activation signals 311, 312 is controlled by the control unit 21 of the vehicle motion control system 2 in such a way that the respective actual wheel rotational speed 71, 72 of a respective wheel 4, 41 is reduced to the desired wheel rotational speed determined for said wheel 4, 41. The braking intervention at the respective wheel 4, 41 is shown in FIG. 2 symbolically by the arrows 33, 34, 35, 36 and is carried out for each wheel 4, 41 individually to a differing degree depending on the desired wheel rotational speed determined for the respective wheel 4, 41. The braking of the motor vehicle 1 resulting from the braking interventions leads to the deceleration, symbolically shown in FIG. 2 with the arrow 93, and to the yaw moment 92, symbolically shown in FIG. 2.

For example, provision may be made that the motor vehicle 1 bends to the right within a radius of 600 m (m: metres) at 50 km/h (km: kilometres; h: hour). The rear wheels 4 of the motor vehicle 1 have the same speed, i.e. the same wheel rotational speed. The front wheels 41 are steered to the right such that the centre point of the motor vehicle 1 lies on the 600 m radius. The right front wheel 41 rolls on a smaller radius R1 than the outer front wheel 41, which rolls on a larger radius R2. Owing to the Ackermann geometry, the speed of the inner (right) and of the outer (left) wheel 41 on the front axle can now be determined. When a vehicle user or an AD driving system changes the driving direction input (radius and target speed of the vehicle) and thus the reference driving line RF, the wheel rotational speeds have to follow the Ackermann geometry so that the lateral wheel slip can be minimized and the lateral stability maximized.

The exemplary embodiments illustrated in the figures and explained in conjunction therewith serve to explain the invention and have no limiting effect thereon.

### LIST OF REFERENCE SIGNS

1 Motor vehicle
2 Vehicle motion control system
21 Control unit of the vehicle motion control system
3 Braking system
31 Electromechanical brake actuator
311, 312 Activation signal for brake actuator (31)
32 Brake pedal
321 Deceleration input
33, 34, 35, 36 Braking intervention
4 Wheel
41 Steerable wheel
5 Steer-by-wire steering system
51 Feedback actuator
511 Steering input
52 Steering handle
53 Steering shaft
6 Drive system
61 Actual vehicle speed
62 Accelerator pedal
621 Acceleration input
7 Wheel rotational speed sensor
71, 72 Wheel rotational speed
92 Yaw moment of the motor vehicle (1)
93 Deceleration of the motor vehicle (1)
RF Reference driving line
R1, R2, R3 Circle radius
M Centre point for the circle radii (R1, R2, R3)

1. A method for braking a motor vehicle comprising a vehicle motion control system and a braking system with electromechanical brake actuators, wherein each wheel of the motor vehicle is assigned one of the electromechanical brake actuators, the method comprising:
receiving, by the vehicle motion control system, a driving direction input comprising a deceleration input, an actual vehicle speed, and an actual wheel rotational speed for each wheel of the motor vehicle;
determining, on the basis of the received driving direction input and the received actual vehicle speed, by the vehicle motion control system, a reference driving line for the motor vehicle;
determining, by the vehicle motion control system, a desired wheel rotational speed which is required to comply with the reference driving line and to implement the deceleration input; and
activating, by the vehicle motion control system, the brake actuators, taking into consideration the respectively received actual wheel rotational speed, in such a way that the actual wheel rotational speed is controlled to the desired wheel rotational speed.

2. The method according to claim 1, wherein the motor vehicle comprises a steering system, in which the steering of the steerable wheels of the steering system is designed according to the Ackermann principle, wherein the vehicle motion control system uses the Ackermann geometry on which the Ackermann principle is based for determining the desired wheel rotational speed.

3. The method according to claim 1, wherein for determining the desired wheel rotational speed, the vehicle motion control system takes into consideration a reference wheel slip, which results from the driving direction input, and the received actual vehicle speed.

4. The method according to claim 1, wherein the vehicle motion control system determines a desired wheel rotational speed for each wheel of the motor vehicle, and the vehicle motion control system activates the brake actuator, which is assigned to a wheel, in accordance with the desired wheel rotational speed determined for the wheel.

5. The method according to claim 1, wherein the brake actuators are activated without the use of a braking force sensor.

6. The method according to claim 1, wherein the driving direction input comprises a steering input detected by a steer-by-wire steering system of the motor vehicle.

7. The method according to claim 1, wherein the driving direction input comprises a deceleration input detected by a brake-by-wire braking system of the motor vehicle.

8. The method according to claim 1, wherein the driving direction input comprises an acceleration input detected by a drive-by-wire drive system of the motor vehicle.

9. A motor vehicle, comprising:
a vehicle motion control system;
a steer-by-wire steering system; and
a braking system with electromechanical brake actuators, wherein each wheel of the motor vehicle is assigned in each case one of the electromechanical brake actuators and a wheel rotational speed sensor for detecting an actual wheel rotational speed of the wheel'
wherein the vehicle motion control system is configured:
to receive a driving direction input comprising a deceleration input, an actual vehicle speed, and an actual wheel rotational speed for each wheel of the motor vehicle;
on the basis of the driving direction input and the actual vehicle speed, to determine a reference driving line for the motor vehicle and a desired wheel rotational speed which is required to comply with the reference driving line and to implement the deceleration input; and
to activate the brake actuators, taking into consideration the respectively received actual wheel rotational speed, and, in the process, to control the actual wheel rotational speed to the desired wheel rotational speed.

10. The motor vehicle according to claim 9, wherein the steerable wheels of the motor vehicle are designed in accordance with an axle-pivot steering system according to the Ackermann principle, and the vehicle motion control system is further configured to use the Ackermann geometry on which the Ackermann principle is based for determining the desired wheel rotational speed.

11. The motor vehicle according to claim 9, wherein the vehicle motion control system is further configured to activate each brake actuator individually.

12. The motor vehicle according to claim 9, wherein the motor vehicle does not comprise any sensors for detecting a braking force and/or an application force.
